(19) United States
(12) Patent Application Publication
(10) Pub. No.: US 2016/0157612 A1
(43) Pub. Date: Jun. 9, 2016

(54) CHAIR FOR MOVIE WATCHING AND MOTION CONTROL METHOD THEREOF AND THEATER MANAGEMENT APPARATUS USING THAT AND METHOD THEREOF

(71) Applicant: CJ 4DPLEX CO., LTD, Jongno-gu, Seoul (KR)

(72) Inventors: Jae Won LIM, Seoul (KR); Chan Min MOON, Seongnam-si (KR)

(73) Assignee: CJ 4DPLEX CO., LTD, Jongno-gu, Seoul (KR)

(21) Appl. No.: 14/905,085

(22) PCT Filed: Jul. 15, 2014
(86) PCT No.: PCT/KR2014/006393

§ 371 Date: Jan. 14, 2016

(30) Foreign Application Priority Data
Jul. 15, 2013 (KR) 10-2013-0082692

(51) Int. Cl. A47C 1/12; G05B 15/02; A47C 7/00

(52) U.S. Cl. CPC A47C 1/12; A47C 7/00; G05B 15/02

(57) ABSTRACT

Provided are a chair for movie watching capable of controlling a motion according to whether a user is seated and weight of a seated user, and a motion control method thereof. A chair for movie watching according to a first exemplary embodiment of the present disclosure includes: a chair main body; a motion generation unit configured to generate a motion to the chair main body according to contents of a currently shown movie; a pressure sensor unit configured to detect a pressure applied to the chair main body, and measure weight of a seated user; and a controller configured to control an operation of the motion generation unit according to a result of the detection by the pressure sensor unit and a result of the measurement of the weight by the pressure sensor unit.

### TECHNICAL FIELD

The present disclosure relates to a chair for movie watching, a motion control method thereof, and a theater management apparatus and method linked to the chair for movie watching, and more particularly, to a chair for movie watching capable of controlling a motion generation function, and a motion control method thereof, and a theater management apparatus and method linked to the chair for movie watching capable of counting a seat occupation ratio and performing statistical compiling calculation for each index.

### BACKGROUND ART

In a theater in the related art, only a simple 2D image is shown. Recently, a 4D theater enabling movie watchers to watch movie while feeling the situation through five senses, such as sight, touch, and smell, and taste, as if experiencing a situation in the movie appears together with a 3D theater showing a 3D image enabling movie watchers to feel a 3D effect, which is very appealing to movie watchers. For example, in the 4D theater, an effect that a chair for a movie watcher is shaken according to a movement of a vehicle in images, the wind blows in a scene in which an object falls from the sky, or water is actually falling within the theater in a scene in which a main character gets rained on is provided together with the images.

In order to provide the aforementioned physical effect, a chair for a movie watcher installed in a 4D theater is mounted with various special devices. A representative device is a motion generation device for generating a movement, that is, a motion, such as vibration or inclination, to the chair.

However, in the case of the chairs currently installed in the 4D theater, a motion is generated to all of the chairs within the theater regardless of whether a person is sitting on a chair, such that power is unnecessarily wasted. A motion with the same level is generated for all of the chairs without considering weight of a respective movie watcher, so that there is a problem in that a failure generation probability in a chair in which a person who weighs more is seated is increased. Further, the motion with same intensity is generated for all of the chairs. Accordingly, there is a problem in that the chair cannot meet the demands of movie watchers desiring to adjust the motion intensity to be greater or lighter.

In the meantime, in the theater in the related art, a movie watcher buys a ticket for a movie which the movie watcher wants to watch. A name of a theater where a corresponding movie is shown among various theaters, and a seat number with a column and a number of the theater are specified in the movie ticket.

A guide at an entrance checks the theater name and the seat number of the ticket presented when a movie watcher enters. Then, the guide guides the movie watcher to the corresponding theater. Then, the movie watcher checks a seat chart of the corresponding theater, and is seated in a seat corresponding to the seat number and watches the movie.

However, the guide may not check each of all of the tickets presented by the ticket holder. When the guide fails to accurately check a movie ticket of a different date, a malicious movie watcher may enter the theater. In this case, a movie watcher cannot help but enter the theater and sitting in a vacant seat with a seat number different from a seat number specified in a bought ticket. Since the guide checks the ticket only at the entrance, the guide cannot individually check the seats in which the movie watchers currently are seated within the theater.

As described above, in the theater in the related art, whether the seat is occupied may be indirectly recognized through ticket sale and cheek work by the guide. However, in the theater in the related art, there is a problem in that it is difficult to accurately count a seat in which a movie watcher is actually seated within the theater. Further, a plurality of theaters is present in the movie theater. Currently, statistical work for seats in which movie watchers are actually seated for each theater or each time zone has not been performed.

### DISCLOSURE

### Technical Problem

The present disclosure is suggested in order to solve the aforementioned problems, and an object of the present disclosure is to provide a chair for movie watching capable of controlling a motion according to whether a user is seated and weight of a seated user, and a motion control method thereof.

Further, an object of the present disclosure is to provide a chair for movie watching capable of directly adjusting a motion intensity according to preference of a seated user, and a motion control method thereof.

In the meantime, an object of an exemplary embodiment of the present disclosure is to provide a theater management apparatus and method, which analyze a log file related to driving each chair for movie watching received from a plurality of chairs for watching a movie, theater facility information, and showing information, count an occupation ratio of seats of a theater, and calculate statistical data for each index.

### Technical Solution

In order to achieve the aforementioned objects, a chair for movie watching according to a first exemplary embodiment of the present disclosure includes: a chair main body; a motion generation unit configured to generate a motion to the chair main body according to contents of a currently shown movie; a pressure sensor unit configured to detect a pressure applied to the chair main body, and measure weight of a seated user; and a controller configured to control an operation of the motion generation unit according to a result of the detection by the pressure sensor unit and a result of the measurement of the weight.

When there is no seated user or the measured weight is equal to or greater than a predetermined value according to the result of the detection by the pressure sensor unit, the controller may stop the operation of the motion generation unit. Further, the controller may adjust a motion intensity of the motion generation unit according to the measured weight.

Further, the chair for movie watching according to the first exemplary embodiment may further include a notifying unit configured to notify the seated user of an operation state of the motion generation unit.

A chair for movie watching according to a second exemplary embodiment of the present disclosure includes: a chair main body; a motion generation unit configured to generate a motion to the chair main body according to contents of a currently shown movie; a pressure sensor unit configured to detect a pressure applied to the chair main body, and measure weight of a seated user; a user input unit configured to receive motion selection information from the seated user; and a controller configured to adjust a motion intensity of the motion generation unit according to a result of the detection by the pressure sensor unit and the received motion selection information.

When there is no seated user or the measured weight is equal to or greater than a predetermined value according to the result of the detection by the pressure sensor unit, the controller may stop the operation of the motion generation unit. The controller may adjust a range of a drivable motion intensity of the motion generation unit according to the measured weight, and adjust a motion intensity of the motion generation unit according to the received motion selection information.

The chair for movie watching according to the second exemplary embodiment may further include a notifying unit configured to notify the seated user of an operation state of the motion generation unit.

A motion control method of a chair for movie watching according to the first exemplary embodiment of the present disclosure is a motion control method of a chair for movie watching which generates a motion to a chair main body according to contents of a currently shown movie, and includes: determining whether a user is seated by detecting a pressure applied to the chair main body; measuring weight of a seated user when the user is seated as a result of the determination; and controlling a motion of the chair main body according to the result of the determination and the measured weight.

The controlling of the motion of the chair main body may include generating no motion to the chair main body when there is no seated user or the measured weight is equal to or greater than a predetermined value according to the result of the determination. Further, the controlling of the motion of the chair main body may include adjusting a motion intensity of the chair main body according to the measured weight.

A motion control method of a chair for movie watching according to the second exemplary embodiment of the present disclosure is a motion control method of a chair for movie watching which generates a motion to a chair main body according to contents of a currently shown movie, and includes: determining whether a user is seated by detecting a pressure applied to the chair main body; measuring weight of a seated user when the user is seated as a result of the determination; receiving motion selection information from the seated user; and controlling a motion of the chair main body according to the result of the determination, and the received motion selection information.

The controlling of the motion of the chair main body may include generating no motion to the chair main body when there is no seated user or the measured weight is equal to or greater than a predetermined value according to the result of the determination. Further, the controlling of the motion of the chair main body may include adjusting a range of a drivable motion intensity of the motion generation unit according to the measured weight, and adjusting a motion intensity of the motion generation unit according to the received motion selection information.

A theater management apparatus linked to a chair for movie watching according to a third exemplary embodiment of the present disclosure includes: a chair linked unit configured to communicate with a plurality of chairs for watching a movie, and receive a log file related to driving of each chair for movie watching; a theater information management unit configured to receive theater facility information about a theater, in which the plurality of chairs for watching a movie is installed, and showing information about a theater; and an information statistic compiling unit configured to analyze the log file received from the chair linked unit and the theater facility information and the showing information received from the theater information management unit, and statistically compiling a seat occupation ratio of the theater by using a result of the analysis.

The information statistic compiling unit may check user seated information in an excess or normal category recorded in the received log file, and statistically calculate a seat occupation ratio including at least one of the number of scats in an excess category, the number of seats in a normal category, the number of non-occupied seats, and the number of summed seats of the entire theaters at a time before a predetermined time.

The information statistic compiling unit may check a name of a movie, a genre of a movie, or a time of a movie from the received showing information and user seated information from the received log file, and calculate at least one of a seat occupation ratio for each of the currently shown movies, a seat occupation ratio for each genre of the movie, and a seat occupation ratio for each theater based on the checked showing information and log file.

The information statistic compiling unit may check user seated information from the received log file and ticket sale information from the received showing information, and check whether a user, who buys a ticket, but does not actually enter, is seated, or whether a user, who is not seated in a seat corresponding to a bought ticket and is actually seated in another seat, is seated, based on the checked showing information and log file.

A theater management method linked to a chair for movie watching according to a third exemplary embodiment of the present disclosure includes: communicating with a plurality of chairs for watching a movie, and receiving a log file related to driving of each chair for movie watching; receiving theater facility information about a theater, in which the plurality of chairs for watching a movie is installed, and showing information about a theater; analyzing the received log file and the received theater facility information and showing information; and calculating statistically a seat occupation ratio of a theater by using the result of the analysis.

The calculating statistically a seat occupation ratio of a theater may include statistically calculating a seat occupation ratio including at least one of the number of seats in an excess category, the number of seats in a normal category, the number of non-occupied seats, and the number of summed seats of the entire theaters at a time before a predetermined time by using a result of the analysis for user seated information in an excess or normal category recorded in the received log file.

The calculating statistically a seat occupation ratio of a theater may include checking a name of a movie, a genre of a movie, or a time of a movie from the received showing information and user seated information from the received log file, and calculating at least one of a seat occupation ratio for each of the currently shown movies, a seat occupation ratio for each genre of the movie, and a seat occupation ratio for each theater based on the checked showing information and log file.

The calculating statistically a seat occupation ratio of a theater may include checking ticket sale information from the received showing information and user seated information from the received log file, and checking whether a user, who buys a ticket, but does not actually enter, is seated, or whether a user, who is not seated in a seat corresponding to a bought ticket and is actually seated in another seat, is seated, based on the checked showing information and log file.

### Advantageous Effects

According to the present disclosure, it is possible to determine whether to generate a motion of the chair for movie watching according to whether a user is seated, and adjust a motion intensity according to the weight of a seated user, thereby preventing an unnecessary operation of a machine to reduce power consumption, and suppressing an excessive operation to prevent a failure and extend a life of the machine.

Further, according to the present disclosure, it is possible to enable a user to directly select a motion intensity within an appropriate range according to weight of a seated user, thereby securing a stable operation of the chair for movie watching, and maximizing satisfaction of a movie watcher of five-sense experiential movie watching.

Further, according to the exemplary embodiments of the present disclosure, there is an effect of counting a seat occupation ratio for each seat during the showing of the movie, and statistically calculating the number of seats in an excess category, the number of seats in a normal category, the number of non-occupied seats, and the number of summed seats of the entire theaters at a time before a predetermined time. (for example, 30 minutes before an end of the showing of the movie).

Further, according to the exemplary embodiments of the present disclosure, it is possible to check whether a user entering a theater is seated for each movie, each genre of a movie, and each showing time, and statistically check a seat occupation ratio or theater current condition information.

### DESCRIPTION OF DRAWINGS

FIGS. 1 and 2 are configuration diagrams illustrating a chair for movie watching according to a first exemplary embodiment of the present disclosure.

FIGS. 3 and 4 are configuration diagrams illustrating a chair for movie watching according to a second exemplary embodiment of the present disclosure.

FIG. 5 is a flowchart illustrating a motion control method of the chair for movie watching according to the first exemplary embodiment of the present disclosure.

FIG. 6 is a flowchart illustrating a motion control method of the chair for movie watching according to the second exemplary embodiment of the present disclosure.

FIG. 7 is a configuration diagram illustrating a theater management apparatus linked to the chair for movie watching according to another exemplary embodiment of the present disclosure.

FIG. 8 is a flowchart illustrating a theater management method linked to the chair for movie watching according to another exemplary embodiment of the present disclosure.

### BEST MODE

The above-described objects, features and advantages will be described below in detail with reference to the accompanying drawings, and accordingly the technical spirit of the present disclosure may be easily implemented by those having ordinary skill in the art. When it is judged that specific description about known technologies related to the present disclosure may unnecessarily obscure the essentials of the present disclosure, the detailed description will be omitted. Hereinafter, an exemplary embodiment according to the present disclosure will be described with reference to the accompanying drawings in detail.

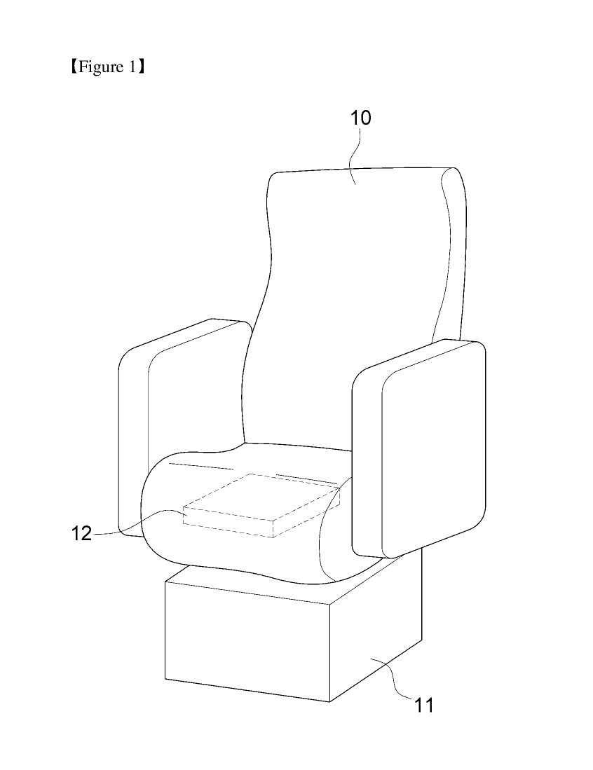

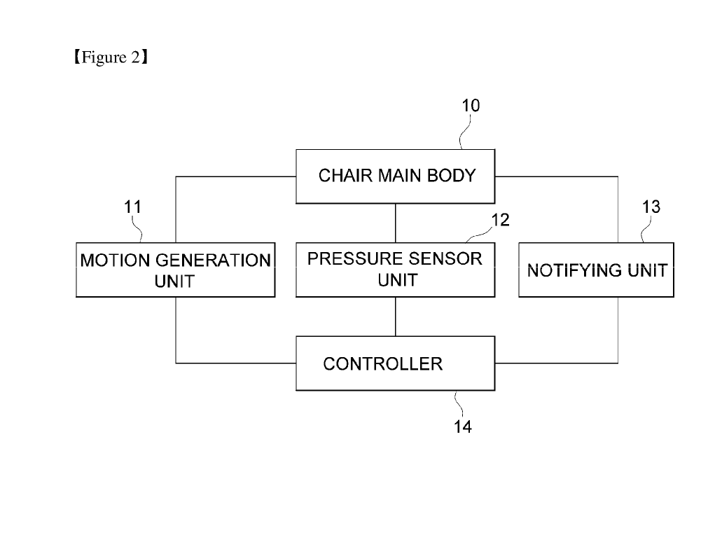

FIGS. 1 and 2 are configuration diagrams illustrating a chair for movie watching according to a first exemplary embodiment of the present disclosure.

Referring to FIGS. 1 and 2, the chair for movie watching according to the first exemplary embodiment of the present disclosure includes a chair main body 10, a motion generation unit 11, a pressure sensor unit 12, and a controller 14. Further, the chair for movie watching may further include a notifying unit 13 notifying a seated user of an operation state of the motion generation unit 11.

The motion generation unit 11 generates a motion to the chair main body 10 according to contents of a currently shown movie. The motion generation unit 11 may generate a motion for improving a sense of reality of a movie by various methods, such as a method of rotating the chair main body 10 or generating a vibration according to contents of the movie.

In order to improve a sensory effect of a movie and prevent a physical difficulty for a seated user, the motion generation unit 11 may implement three degrees of freedom motion (pitch, roll, and heave) by installing three moving means moving up and down at three positions in a lower portion of the chair main body 10. When the three degrees of freedom motion are used, a user may receive an effect of a movement in front and rear directions through the pitch motion. A user may receive an effect of a horizontal movement through the roll motion. A user may receive an effect of a vertical movement through the heave motion.

The pressure sensor unit 12 detects a pressure applied to the chair main body 10, and measures weight of a seated user.

Here, the pressure sensor unit 12 may be mounted in a lower cushion of the chair main body 10. In general, a user watching a movie in a theater cannot maintain the same pose (for example, a pose of leaning against the chair with the back) for a long time. However, hips are always in contact with the lower cushion, and weight of a user is mostly concentrated toward the hips, so that when the pressure sensor unit 12 is mounted in the lower cushion, it is possible to more accurately measure weight.

The controller 14 controls an operation of the motion generation unit 11 according to a result of the user detection and a result of the weight measurement of the pressure sensor unit 12. The controller 14 controls the motion generation unit 11 by a method of stopping an operation of the motion generation unit 11, adjusting a motion intensity, and the like.

When any pressure is not detected by the pressure sensor unit 12, the controller 14 may determine that a user is not seated, and stop the operation of the motion generation unit 11.

In this case, the user detection of the pressure sensor unit 12 is performed only for a predetermined time (for example, 30 minutes) after a start of a movie. The controller 14 may stop an operation of a chair, in which a user is not seated, from a time after the predetermined time.

When the measured weight of the seated user is equal to or greater than a predetermined value, the controller 14 may stop an operation of the motion generation unit 11 in order to prevent a failure of a machine. In this case, the notifying unit 13 may notify the seated user of the stop of the motion generation unit 11 by generating an alarm (for example, a sound or flickering of a seat number).

Further, the controller 14 may adjust a motion intensity of the motion generation unit 11 according to the measured weight. For example, the controller 14 may adjust the intensity of the motion, such as a vibration, to be slightly light for a person who weighs less. The controller may adjust the motion intensity to be stronger within a range, in which the machine is not affected, for a person who weighs more. Through the method, a user customized motion may be provided to a user.

Here, when the range of the drivable motion intensity during a normal operation of the motion generation unit 11 is 0 to 100, the controller 14 makes the motion generation unit 11 drive the motion within the whole range of 0 to 100 when weight of the seated user is equal to or lower than 60 kg. When weight of the user is 60 to 80 kg, the controller 14 may adjust the range of the drivable motion intensity to 0 to 70. When weight of the user is 80 to 100 kg, the controller 14 may adjust the range of the drivable motion intensity to 0 to 50.

In addition, the controller 14 may transmit a predetermined motion recommended intensity value based on the weight measured by the pressure sensor unit 12 to the motion generation unit 11, as well as the range of the motion intensity, and designate the predetermined motion recommended intensity value as an initial motion intensity value. The initial motion intensity value may be determined by a predetermined ratio (for example, 70% or 80%) in the range of the total motion intensities. For example, when weight of the seated user is equal to or lower than 60 kg, the controller 14 may control the motion intensity by a motion intensity recommended value of 70 that is a value corresponding to a ratio of 70% in the range of 0 to 100. Further, when weight of the seated user is 60 to 80 kg, the controller 14 may control the motion intensity by a motion intensity recommended value of 49 that is a value corresponding to a ratio of 70% in the range of 0 to 70.

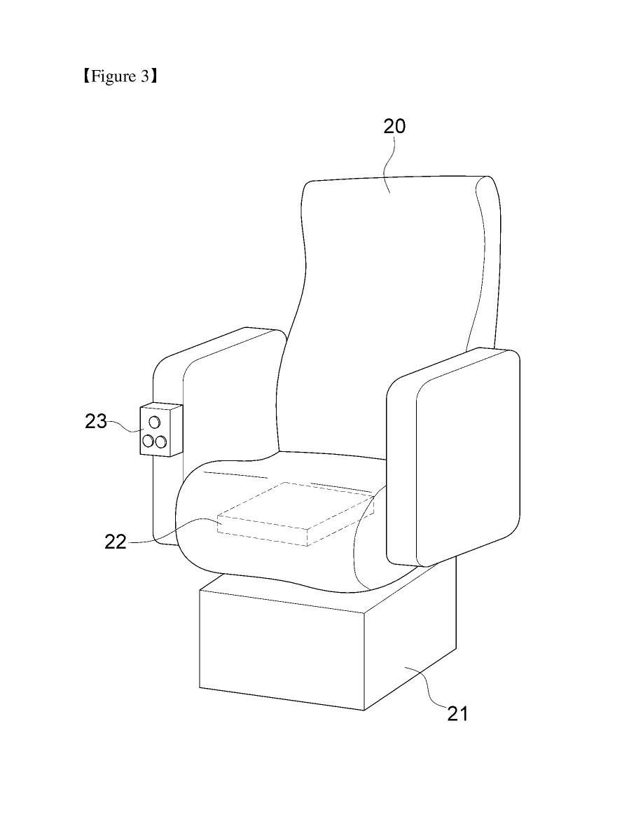

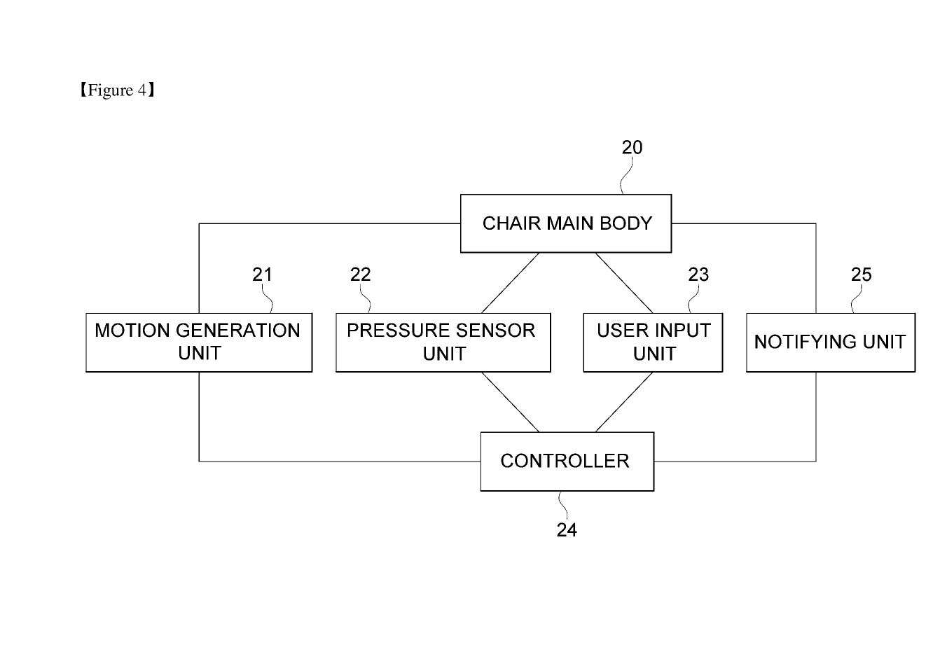

FIGS. 3 and 4 are configuration diagrams illustrating a chair for movie watching according to a second exemplary embodiment of the present disclosure.

Referring to FIGS. 3 and 4, a chair for movie watching according to a second exemplary embodiment of the present disclosure includes a chair main body 20, a motion generation unit 21, a pressure sensor unit 22, a user input unit 23, and a controller 25. Further, the chair for movie watching may further include a notifying unit 24 notifying a seated user of an operation state of the motion generation unit 21.

The motion generation unit 21 generates a motion to the chair main body 20 according to contents of a currently shown movie. The motion generation unit 21 may generate a motion for improving a sense of reality of a movie by various methods, such as a method of rotating the chair main body 20 or generating a vibration according to contents of the movie.

In order to improve a sensory effect of a movie and prevent a physical difficulty for a seated user, the motion generation unit 21 may implement three degrees of freedom motion (pitch, roll, and heave) by installing three moving means moving up and down at three positions in a lower portion of the chair main body 20. When the three degrees of freedom motion are used, a user may receive an effect of a movement in front and rear directions through the pitch motion. A user may receive an effect of a horizontal movement through the roll motion. A user may receive an effect of a vertical movement through the heave motion.

The pressure sensor unit 22 detects a pressure applied to the chair main body 20, and measures weight of a seated user.

Here, the pressure sensor unit 22 may be mounted in a lower cushion of the chair main body 20. In general, a user watching a movie in a theater cannot maintain the same pose (for example, a pose of leaning against the chair with the back) for a long time, but hips are always in contact with the lower cushion, and weight of a user is mostly concentrated toward the hips, so that when the pressure sensor unit 12 is mounted in the lower cushion, it is possible to more accurately measure weight.

The user input unit 23 receives motion selection information from the seated user. The user input unit 23 receives the motion selection information through which the seated user may directly select the motion intensity. The user input unit 23 may be positioned at a part, such as an armrest part or a part under the legs of the chair main body 20, which a hand of the user easily reaches, and is provided in the form of a button or a rotational dial, thereby enabling the user to select a desired level of the motion intensity.

The controller 25 controls a motion intensity of the motion generation unit 21 according to a result of the detection by the pressure sensor unit 22 and the motion selection information input through the user input unit 23.

When any pressure is not detected by the pressure sensor unit 22, the controller 25 may determine that a user is not seated, and stop the operation of the motion generation unit 21.

In this case, the user detection of the pressure sensor unit 22 is performed only for a predetermined time (for example, 30 minutes) after a start of a movie. The controller 25 may stop an operation of a chair, in which a user is not seated, from a time after the predetermined time.

When the user is seated and inputs the motion selection information, the controller 25 may drive the motion generation unit 21 with the selected motion intensity.

In this case, the controller 25 may adjust a range of the drivable motion intensity of the motion generation unit 21 according to the weight measured by the pressure sensor unit 22. For example, when the range of the drivable motion intensity during a normal operation of the motion generation unit 21 is 0 to 100, the controller 25 makes the motion generation unit 11 to drive the motion within the whole range of 0 to 100 when weight of the seated user is equal to or lower than 60 kg. When weight of the user is 60 to 80 kg, the controller 25 may adjust the range of the drivable motion intensity from 0 to 70. When weight of the user is 80 to 100 kg, the controller 25 may adjust the range of the drivable motion intensity from 0 to 50.

In addition, the controller 25 may transmit a predetermined motion recommended intensity value based on the weight measured by the pressure sensor unit 22 to the motion generation unit 21, as well as the range of the motion intensity, and designate the predetermined motion recommended intensity value as an initial motion intensity value. The initial motion intensity value may be determined by a predetermined ratio (for example, 70% or 80%) in the range of the total motion intensities. For example, when weight of the seated user is equal to or lower than 60 kg, the controller 25 may control the motion intensity by a motion intensity recommended value of 70 that is a value corresponding to a ratio of 70% in the range of 0 to 100. Further, when weight of the seated user is 60 to 80 kg, the controller 25 may control the motion intensity by a motion intensity recommended value of 49 that is a value corresponding to a ratio of 70% in the range of 0 to 70.

When the weight of the user exceeds 100 kg, the controller 25 may stop the operation of the motion generation unit 21. In this case, the notifying unit 24 may notify the seated user of the stop of the motion generation unit 21 may by generating an alarm (for example, a sound or flickering of a seat number).

As described above, the chair for movie watching according to the exemplary embodiments of the present disclosure may provide a user with a user customized motion, thereby further improving satisfaction of experiential movie watching. Further, the chair for movie watching according to the exemplary embodiments of the present disclosure may secure a normal operation of the chair for movie watching, and prevent various failures caused by an excessive operation.

The notifying unit 24 may provide the user with information on an operation state of the motion generation unit 21. For example, the notifying unit 24 may provide information on whether an operation is currently performed, a range of the drivable motion intensity, and a selected motion intensity. To this end, a separate display device (not illustrated) may be additionally mounted in the chair. When a predetermined initial motion intensity value is designated, the notifying unit 24 may provide the user with the initial motion intensity value through the separate display device. In this case, the user input unit 23 may be combined with the display device to be implemented as a touch interface.

In the meantime, in the chair for movie watching according to the present disclosure, a plurality of chairs may be installed in an integrated form of one assembly. For example, two or four chairs are combined and installed as one assembly for each column of the seats of the movie theater. Accordingly, the chair for movie watching according to the present disclosure may improve efficiency in utilizing a space, and enable other special effect devices to be more easily installed.

As described above, when the plurality of chairs is combined into one assembly, the controller 14 may calculate a weight ratio of a left side and a right side of one assembly in which the plurality of chairs is combined by using the weight measured by the pressure sensor unit 12 installed at each seat. Further, the controller 14 may adjust an intensity of a left motion and an intensity of a right motion of the motion generation unit 11 to be different from each other according to the calculated weight ratio of the left side and the right side. For example, when a person who weighs less is seated at the left side of the assembly, and a person who weighs more is seated at the right side of the assembly, the controller 14 may adjust the motion intensity of the motion generation unit 11 by applying a weighted value to the weight ratio of the left side and the right side, or inverse-proportionally correcting the motion intensity.

When the plurality of chairs is combined into one assembly, the user input unit 23 may receive a plurality of pieces of motion selection information through which a plurality of seated users may directly select the motion intensity. Further, the controller 25 may adjust the motion intensity of the motion generation unit 21 driving one assembly, in which the plurality of chairs is combined, according to one motion selection information among the plurality of pieces of motion selection information. For example, the controller 26 may calculate an average motion intensity of the plurality of motion intensities, and adjust the motion intensity of the motion generation unit 21 according to the calculated average motion intensity. Further, the controller 25 may check the most selected motion intensity among the plurality of motion intensities, and adjust the motion intensity of the motion generation unit 21 according to the checked motion intensity.

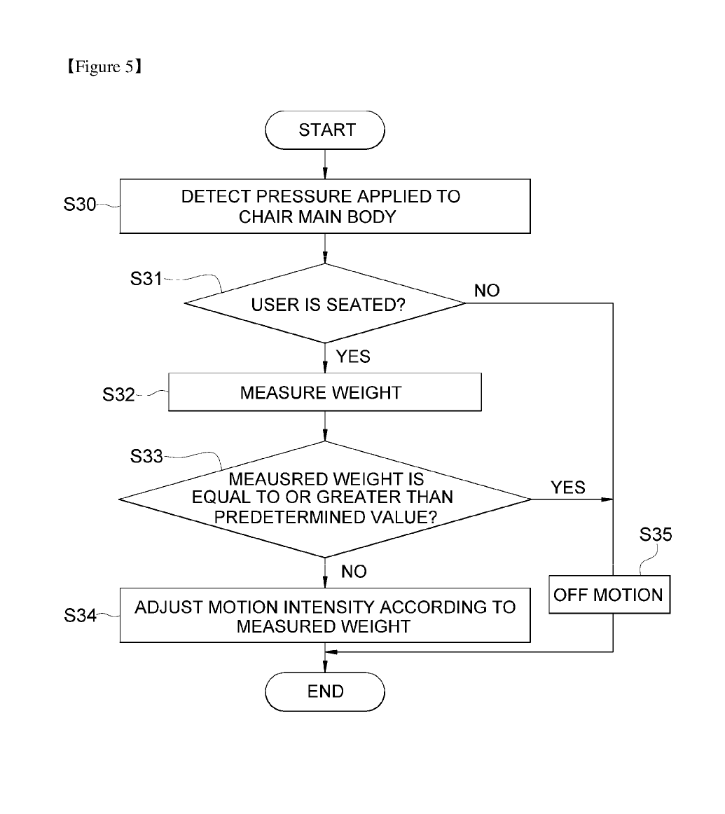

FIG. 5 is a flowchart illustrating a motion control method of the chair for movie watching according to the first exemplary embodiment of the present disclosure. Hereinafter, a motion control method of the chair for movie watching according to the first exemplary embodiment of the present disclosure will be described with reference to FIGS. 1, 2, and 5.

When movie showing starts, the pressure sensor unit 12 mounted at the lower cushion of the chair main body 10 detects a pressure applied to the chair main body 10 (S30).

Next, the controller 14 determines whether a user is seated by using a result of the pressure detection (S31), and measures weight of the seated user through the pressure sensor unit 12 when the user is seated (S32).

Subsequently, the controller 14 checks whether the measured weight is equal to or greater than a predetermined value (for example, 100 kg) (S33). When the measured weight is lower than the predetermined value, that is, the measured weight is weight by which the motion generation unit 11 is operable without difficulty, the controller 14 adjusts a motion intensity according to the measured weight (S34).

In this case, the controller 14 may provide a user customized motion by a method of adjusting the intensity of the motion, such as a vibration, to be slightly light for a person who weighs less, and adjusting the motion intensity to be stronger within a range, in which a machine is not affected, for a person who weighs more. Here, when the range of the drivable motion intensity during a normal operation of the motion generation unit 11 is 0 to 100, the controller 14 makes the motion generation unit 11 drive the motion within the whole range of 0 to 100 when weight of the seated user is equal to or lower than 60 kg. When weight of the user is 60 to 80 kg, the controller 14 may adjust the range of the drivable motion intensity to 0 to 70.

When it is determined that the user is not seated in operation S31, or the measured weight is equal to or greater than the predetermined value in operation S33, the controller 14 may stop the operation of the motion generation unit 11 in order to prevent failure of the machine (535). In this case, the controller 14 may additionally generate an alarm (for example, a sound or flickering of a seat number) through the notifying unit 13 to notify the stop of the motion generation unit 11 to the seated user.

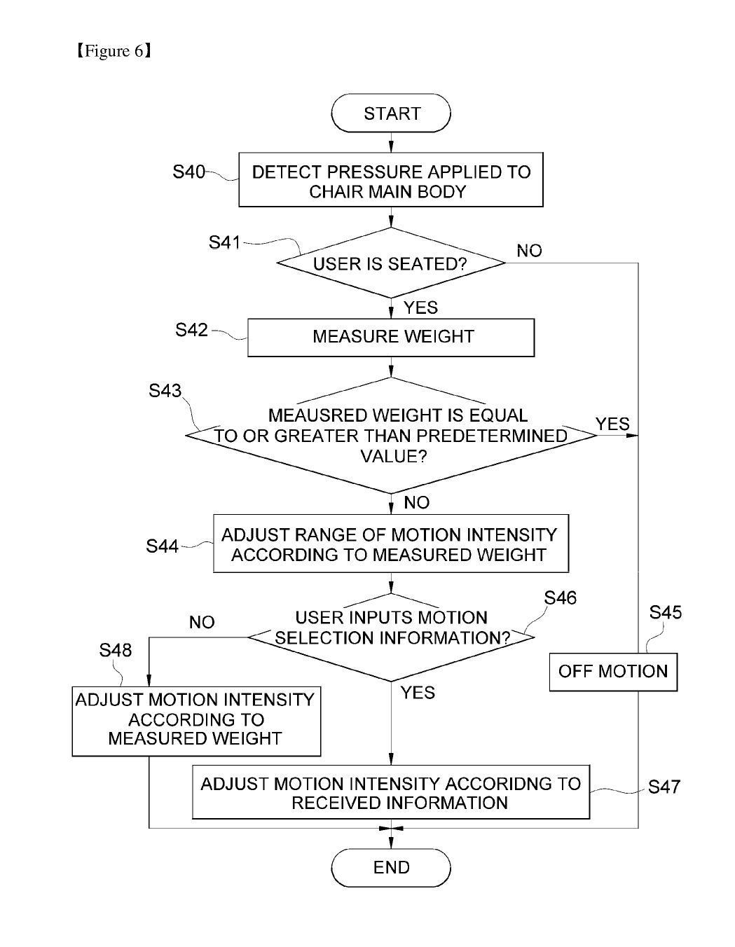

FIG. 6 is a flowchart illustrating a motion control method of the chair for movie watching according to the second exemplary embodiment of the present disclosure. Hereinafter, a motion control method of the chair for movie watching according to the second exemplary embodiment of the present disclosure will be described with reference to FIGS. 3, 4, and 5.

When movie showing starts, the pressure sensor unit 21 mounted at the lower cushion of the chair main body 20 detects a pressure applied to the chair main body 20 (S40).

Next, the controller 25 determines whether a user is seated by using a result of the pressure detection (S41), and measures weight of the seated user through the pressure sensor unit 22 when the user is seated (S42).

Subsequently, the controller 25 checks whether the measured weight is equal to or greater than a predetermined value (for example, 100 kg) (S43). When the measured weight is lower than the predetermined value, that is, the measured weight is weight by which the motion generation unit 21 is operable without difficulty, the controller 25 adjusts a range of a motion intensity according to the measured weight (S44).

For example, when the range of the drivable motion intensity during a normal operation of the motion generation unit 21 is 0 to 100, the controller 25 makes the motion generation unit 11 to drive the motion within the whole range of 0 to 100 when weight of the seated user is equal to or lower than 60 kg. When weight of the user is 60 to 80 kg, the controller 25 may adjust the range of the drivable motion intensity from 0 to 70. When weight of the user is 80 to 100 kg, the controller 25 may adjust the range of the drivable motion intensity from 0 to 50.

When it is determined that the user is not seated in operation S41, and the measured weight is equal to or greater than the predetermined value in operation 43, the controller 25 stops the operation of the motion generation unit 21 (S45). In this case, the controller 25 may additionally generate an alarm (for example, a sound or flickering of a seat number) through the notifying unit 24 to notify the stop of the motion generation unit 21 may be additionally notified to the seated user.

Next, the controller 25 checks whether the user inputs motion selection information through the user input unit 23 (S46). The user sitting in the chair may directly select a desired motion intensity through the user input unit 23. However, in order to secure a smooth operation of the motion generation unit 21, and prevent a failure of the motion generation unit 21, the controller 25 may suppress the user to select the motion intensity within the range of the motion intensity according to the weight of the user determined in operation S44. The user input unit 23 may be positioned at a part, such as an armrest part or a part under the legs of the chair main body 20, which a hand of the user easily reaches. The user input unit 23 is provided in the form of a button or a rotational dial, thereby enabling the user to select a desired level of the motion intensity.

Next, when the user inputs the motion selection information in operation S46, that is, the user selects the desired motion intensity, the controller 25 may adjust the motion intensity according to the input motion selection information (S47), but when the user does not input the motion selection information in operation 846, the controller 25 may autonomously adjust the motion intensity according to the weight measured in operation S42 (S48).

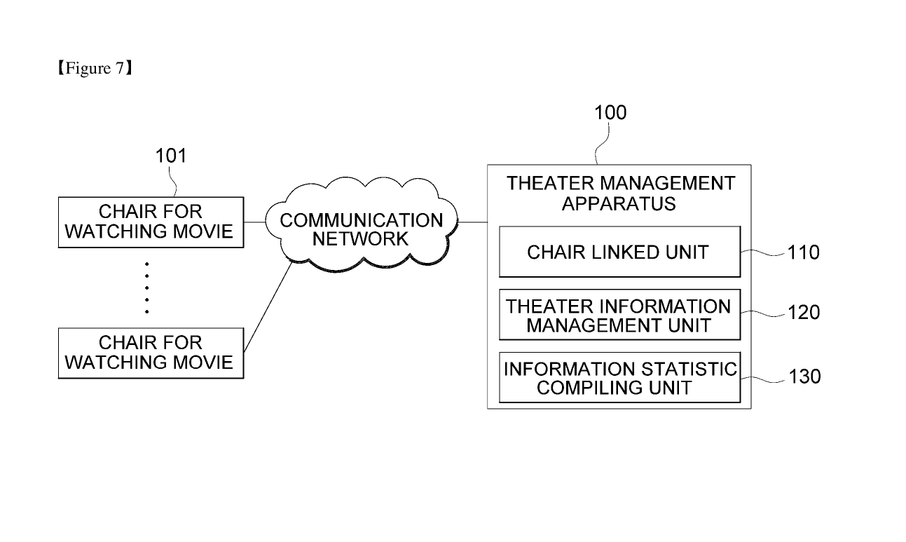

FIG. 7 is a configuration diagram illustrating a theater management apparatus linked to the chair for movie watching according to the exemplary embodiment of the present disclosure.

A theater management apparatus 100 includes a chair linked unit 110, a theater information management unit 120, and an information statistic compiling unit 130.

The theater management apparatus 100 is connected with the plurality of chairs for watching a movie through a communication network. The theater management apparatus 100 receives a log file in real time or periodically through the communication network and analyzes the received log file to perform a statistic compiling process on theater information or showing information.

Hereinafter, each of the constituent elements of the theater management apparatus 100 will be described below.

The chair linked unit 110 receives the log files generated by the plurality of chairs 101 for watching a movie. The chair linked unit 110 may receive the log file generated at a time (for example, 20 minutes or 30 minutes) after a predetermined time after the user is seated in the chair 101 for watching a movie. The log file may include information on a pressure applied to the chair main body detected at each of the plurality of chairs 101 for watching a movie, information on whether a user is seated according to the information on the pressure, information on the measured weight of the user, the motion selection information input by the user, and motion intensity information adjusted according to the motion selection information. For example, the weight of the user sitting in the chair 101 for watching a movie may be recorded with a category of “excess” or “normal” in the log file together with a number of the chair 101 for watching a movie. The chair linked unit 110 may include a log file database for storing the log file.

The theater information management unit 120 receives and manages theater facility information about a theater in which the chair for movie watching is currently installed, showing information about a currently shown movie or a plurality of theaters, and the like. For example, the theater facility information may include other special effect installation information other than a size and motion driving of the theater facility, and chair arrangement information about the positioned chairs. Further, the showing information may include a name of a currently shown movie, a genre of a movie, a time of a movie, sale information about a ticket of each theater, and the like.

The information statistic compiling unit 130 analyzes the log file received from the chair linked unit 110, and the theater facility information and the showing information received from the theater information management unit 120. Particularly, the information statistic compiling unit 130 may statistically calculate a seat occupation ratio of the theater or theater current condition information. For example, the information statistic compiling unit 130 may count a seat occupation ratio for each seat of one chair 101 for watching a movie during the showing of the movie, and statistically calculate the number of seats in an excess category, the number of seats in a normal category, the number of non-occupied seats, and the number of summed seats of the entire theaters at a time before a predetermined time (for example, 30 minutes before an end of the showing of the movie). Further, in the case of the seat occupation ratio of the theater, the information statistic compiling unit 130 may compare user seated information and ticket sale information contained in the showing information, and compare actually sold tickets and the user seated information. For example, the information statistic compiling unit 130 compares the showing information received from the theater information management unit 120 and the user seated information received from the chair linked unit 110 for a predetermined time (for example, 30 minutes) after a start of the movie in real time. The information statistic compiling unit 130 may calculate a seat occupation ratio for each of the currently shown movies, a seat occupation ratio for each genre of the movie, a seat occupation ratio for each theater, and the like based on a result of the comparison in real time. In this case, the information statistic compiling unit 130 may check whether a user, who buys a ticket, but does not actually enter, is seated, or whether a user, who is not seated in a seat corresponding to the bought ticket and is actually seated in another seat, is seated. The information statistic compiling unit 130 may perform a statistic compiling operation by dividing a case where a real-time statistic compilation is demanded, and a case where a real-time statistic compilation is not demanded.

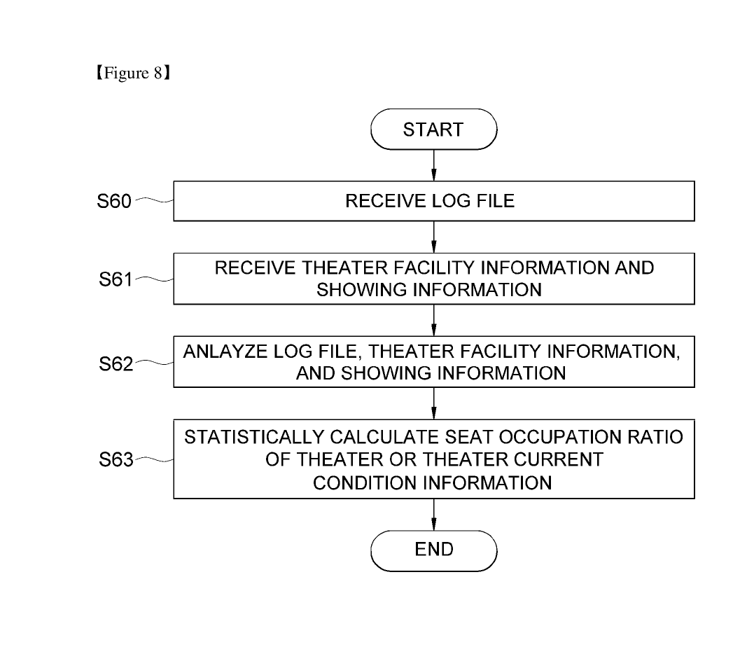

FIG. 8 is a flowchart illustrating a theater management method linked to the chair for movie watching according to the exemplary embodiment of the present disclosure.

The chair linked unit 110 of the theater management apparatus 100 receives a log file through a communication network in real time or periodically (S60).

The theater information management unit 120 receives theater facility information about a theater in which the chair for movie watching is currently installed, showing information about a currently shown movie, and the like (S61).

The information statistic compiling unit 130 analyzes the log file received from the chair linked unit 110, and the theater facility information and the showing information received from the theater information management unit 120 (S62). Here, the weight of the user sitting in the chair 101 for watching a movie may be recorded with a category of “excess” or “normal” in the log file together with a number of the chair 101 for watching a movie.

The information statistic compiling unit 130 may statistically calculate a seat occupation ratio of the theater or theater current condition information (S63). For example, the information statistic compiling unit 130 may count a seat occupation ratio for each seat of one chair 101 for watching a movie during the showing of the movie, and statistically calculate the number of seats in an excess category, the number of seats in a normal category, the number of non-occupied seats, and the number of summed seats of the entire theaters at a time before a predetermined time (for example, 30 minutes before an end of the showing of the movie). Further, the information statistic compiling unit 130 may check a seat occupation ratio for each of the currently shown movies, a seat occupation ratio for each genre of the movie, a seat occupation ratio for each theater, and the like based on the user seated information.

From the foregoing, it will be appreciated that various embodiments of the present disclosure have been described herein for purposes of illustration, and that various modifications may be made by those skilled in the art without departing from the scope and spirit of the present disclosure. The exemplary embodiments disclosed in the specification of the present disclosure will not limit the present disclosure. The scope of the present disclosure shall be construed on the basis of the following claims in such a manner that all of the technical ideas included within the scope equivalent to the claims belong to the present disclosure.

[Description of Main Reference Numerals of Drawings]

| | |
|---|---|
| 10, 20: Chair main body | 11, 21: Motion generation unit |
| 12, 22: Pressure sensor unit | 23: User input unit |
| 13, 24: Notifying unit | 14, 25: Controller |
| 100: Theater management apparatus | 110: Chair linked unit |

120: Theater information management unit
130: Information statistic compiling unit

1. A chair for movie watching, comprising:
a chair main body;
a motion generation unit configured to generate a motion to the chair main body according to contents of a currently shown movie;
a pressure sensor unit configured to detect a pressure applied to the chair main body and measure weight of a seated user; and
a controller configured to control an operation of the motion generation unit according to a result of the detection by the pressure sensor unit and a result of the measurement of the weight by the pressure sensor unit.

2. The chair of claim 1, wherein when there is no seated user or the measured weight is equal to or greater than a predetermined value according to the result of the detection by the pressure sensor unit, the controller stops the operation of the motion generation unit.

3. The chair of claim 1, wherein the controller adjusts a motion intensity of the motion generation unit according to the measured weight.

4. The chair of claim 1, further comprising:
a notifying unit configured to notify the seated user of an operation state of the Motion generation unit.

5. A chair for movie watching, comprising:
a chair main body;
a motion generation unit configured to generate a motion to the chair main body according to contents of a currently shown movie;
a pressure sensor unit configured to detect a pressure applied to the chair main body, and measure weight of a seated user;
a user input unit configured to receive motion selection information from the seated user; and
a controller configured to adjust a motion intensity of the motion generation unit according to a result of the detection by the pressure sensor unit and the received motion selection information.

6. The chair of claim 5, wherein when there is no seated user or the measured weight is equal to or greater than a predetermined value according to the result of the detection by the pressure sensor unit, the controller stops the operation of the motion generation unit.

7. The chair of claim 5, wherein the controller adjusts a range of a drivable motion intensity of the motion generation unit according to the measured weight, and adjusts a motion intensity of the motion generation unit according to the received motion selection information.

8. The chair of claim 5, further comprising:
a notifying unit configured to notify the seated user of an operation state of the motion generation unit.

9. A motion control method of a chair for movie watching which generates a motion to a chair main body according to contents of a currently shown movie, comprising:
determining whether a user is seated by detecting a pressure applied to the chair main body;
measuring weight of a seated user when the user is seated as a result of the determination; and
controlling a motion of the chair main body according to the result of the determination and the measured weight.

10. The motion control method of claim 9, wherein the controlling of the motion of the chair main body includes generating no motion to the chair main body when there is no seated user or the measured weight is equal to or greater than a predetermined value according to the result of the determination.

11. The motion control method of claim 9, wherein the controlling of the motion of the chair main body includes adjusting a motion intensity of the chair main body according to the measured weight.

12. A motion control method of a chair for movie watching which generates a motion to a chair main body according to contents of a currently shown movie, comprising:
determining whether a user is seated by detecting a pressure applied to the chair main body;
measuring weight of a seated user when the user is seated as a result of the determination;
receiving motion selection information from the seated user; and
controlling a motion of the chair main body according to the result of the determination, the measured weight, and the received motion selection information.

13. The motion control method of claim 12, wherein the controlling of the motion of the chair main body includes generating no motion to the chair main body when there is no seated user or the measured weight is equal to or greater than a predetermined value according to the result of the determination.

14. The motion control method of claim 12, wherein the controlling of the motion of the chair main body includes adjusting a range of a drivable motion intensity of the motion generation unit according to the measured weight, and adjusting a motion intensity of the motion generation unit according to the received motion selection information.

15. A theater management apparatus linked to a chair for movie watching, comprising:
a chair linked unit configured to communicate with a plurality of chairs for watching a movie, and receive a log file related to driving each chair for movie watching;
a theater information management unit configured to receive theater facility information about a theater, in which the plurality of chairs for watching a movie is installed, and showing information about a theater; and
an information statistic compiling unit configured to analyze the log file received from the chair linked unit and the theater facility information and the showing information received from the theater information management unit, and statistically compiling a seat occupation ratio of the theater by using a result of the analysis.

16. The theater management apparatus of claim 15, wherein the information statistic compiling unit checks user seated information in an excess or normal category recorded in the received log file, and statistically calculates a seat occupation ratio including at least one of the number of seats in an excess category, the number of seats in a normal category, the number of non-occupied seats, and the number of summed seats of the entire theaters at a time before a predetermined time.

17. The theater management apparatus of claim 15, wherein the information statistic compiling unit checks a name of a movie, a genre of a movie, or a time of a movie from the received showing information and user seated information from the received log file, and calculates at least one of a seat occupation ratio for each of the currently shown movies, a seat occupation ratio for each genre of the movie, and a seat occupation ratio for each theater based on the checked showing information and log file.

18. The theater management apparatus of claim 15, wherein the information statistic compiling unit checks user seated information from the received log file and ticket sale information from the received showing information, and checks whether a user, who buys a ticket, but does not actually enter, is seated, or whether a user, who is not seated in a seat corresponding to a bought ticket and is actually seated in another seat, is seated, based on the checked showing information and log file.

19. A theater management method linked to a chair for movie watching, comprising:
communicating with a plurality of chairs for watching a movie, and receiving a log file related to driving of each chair for movie watching;
receiving theater facility information about a theater, in which the plurality of chairs for watching a movie is installed, and showing information about a theater;
analyzing the received log file and the received theater facility information and showing information; and
calculating statistically a seat occupation ratio of a theater by using the result of the analysis.

20. The theater management method of claim 19, wherein the calculating statistically a seat occupation ratio of a theater includes statistically calculating a seat occupation ratio including at least one of the number of seats in an excess category, the number of seats in a normal category, the number of non-occupied seats, and the number of summed seats of the entire theaters at a time before a predetermined time by using a result of the analysis for user seated information in an excess or normal category recorded in the received log file.

21. The theater management method of claim 19, wherein the calculating statistically a seat occupation ratio of a theater includes checking a name of a movie, a genre of a movie, or a time of a movie from the received showing information and user seated information from the received log file, and calculating at least one of a seat occupation ratio for each of the currently shown movies, a seat occupation ratio for each genre of the movie, and a seat occupation ratio for each theater based on the checked showing information and log file.

22. The theater management method of claim 19, wherein the calculating statistically a seat occupation ratio of a theater includes checking ticket sale information from the received showing information and user seated information from the received log file, and checking whether a user, who buys a ticket, but does not actually enter, is seated, or whether a user, who is not seated in a seat corresponding to a bought ticket and is actually seated in another seat, is seated, based on the checked showing information and log file.
